(19) United States
(12) Patent Application Publication
(10) Pub. No.: US 2011/0235789 A1
(43) Pub. Date: Sep. 29, 2011

(54) Method and Apparatus to Initiate a Communications Device

(75) Inventors: Francesco Lodolo, London (GB); Harsh Jahagirdar, London (GB)

(73) Assignee: NOKIA CORPORATION, Espoo (FI)

(21) Appl. No.: 13/132,912

(22) PCT Filed: Dec. 2, 2009
(86) PCT No.: PCT/IB2009/055460

§ 371 Date: Jun. 3, 2011

(30) Foreign Application Priority Data
Dec. 10, 2008 (GB) 0822521.1

(51) Int. Cl. H04M 11/00

(52) U.S. Cl. 379/90.01

(57) ABSTRACT

To reduce memory space for storing applications only one copy, of otherwise duplicate coding, may be provided in a telecommunications device. To ensure that certain telephony functions are enabled relatively quickly on start-up of the device the invention provides a method of initialising telephony functionality and then initialising other functionality in two sequential phases, where the first phase includes initialising parts of the other functionality that are relied on by the telephone functionality prior to initialising other parts that the telephony functionality does not use.

### TECHNICAL FIELD

The present invention relates to a method and apparatus to initiate a communications device, and in particular, but not exclusively, a mobile telecommunications device.

### BACKGROUND TO THE INVENTION

In many communications devices software code is used to perform many tasks relating to the functions (e.g. telephony, multimedia production or reproduction, etc.) that the device may perform. However, although the same particular task (e.g. voice processing) may be performed for two or more different functions of the device, usually the same software code is included on the device multiple times, for each function to be performed.

### SUMMARY OF THE INVENTION

Various examples of the invention are set out in the claims.

According to a first aspect, the invention provides a method, comprising: initiating telephony functionality in a communications device, the telephony functionality being provided by a telephony function and one or more telephony-related parts of one or more other functions, the one or more other functions further having non-telephony related parts, the initiating further comprising: initialising the telephony function; and initialising the one or more telephony-related parts of the one or more other functions prior to the non-telephony related parts.

According to a second aspect, the invention provides an apparatus, comprising: at least one processor; and at least one memory including computer program code, the at least one memory and the computer program code configured to, with the at least one processor, cause the apparatus to perform at least the following: initiate telephony functionality in the apparatus, the telephony functionality being provided by a telephony function and one or more telephony-related parts of one or more other functions, the one or more other functions further having non-telephony related parts, the initiation further comprising: initialising the telephony function; and initialising the one or more telephony-related parts of the one or more other functions prior to the non-telephony related parts.

According to a third aspect the invention provides an apparatus, comprising: a telephony module that provides at least in part telephony functionality to the apparatus; and one or more further functional modules, having telephony related parts and non-telephony related parts, the telephony-related parts being operable with the telephony module to provide telephony functionality to the apparatus; wherein, on initiating the apparatus the telephony module is initialised, and the telephony-related part(s) of the or each further functional modules is/are initialised prior to the non-telephony-related parts.

According to a fourth aspect the invention provides a computer program or suite of computer programs so arranged such that when executed by a computer it/they cause the computer to operate in accordance with the method of the first aspect noted above.

According to a fifth aspect the invention provides a computer program or suite of computer programs according to the fourth aspect above, wherein the computer program or suite of computer programs is a computer program product comprising a computer-readable medium bearing computer program code embodied therein for use with a computer.

In one example, there is also provided a method of initiating a telecommunications device comprising: initialising telephony functionality; and initialising multimedia functionality in two sequential phases.

In one example, in the first of the two said sequential phases at least a voice processing component is initialised. In one example, in the second of the two said sequential phases other multimedia components are initialised.

In one example the initialisation in the first of the two said sequential phases occurs synchronously.

In one example the initialisation in the second of the two said sequential phases occurs either synchronously or asynchronously.

In one example the telecommunications device is able to facilitate the making of a telephone call following the initialisation in the first of the two said sequential phases.

### DESCRIPTION OF THE DRAWINGS

For a more complete understanding of example embodiments of the present invention, reference is now made to the following descriptions taken in connection with the accompanying drawings in which:

FIG. 1 is a schematic diagram of a communications device;

FIG. 2 is a block diagram representing the communications device of FIG. 1;

FIG. 3 is a flow diagram of a method of initiating a communications device according to one embodiment of the present invention;

FIG. 4 is a schematic diagram of another communications device;

FIG. 5 is a diagram of a resource controller in one example embodiment of the invention; and

FIG. 6 is a flow diagram of a method in one example embodiment.

### DETAILED DESCRIPTION OF EXAMPLE EMBODIMENTS

In several examples the term communications device as used herein in relation to such examples includes mobile and non-mobile communication devices. In such examples the term is to be expansively construed to cover any communication device of any form including mobile telephones, data recording devices, hand held and personal computers such as Personal Digital Assistants (PDAs), smart telephones, communicators which combine communications, image recording and/or playback and computing functionality within a single device, and other forms of wireless and wired information devices including telecommunications functionality.

In one example, electronic communications devices may include telephony functionality for facilitating the making and receiving of telephone calls. This telephone functionality may include, in one example, voice processing. In one example the functionality may be described by application programming interfaces (APIs), and may be provided by software modules such as Digital Signal Processing (DSP) codecs.

Some communications devices also include, in some examples, multimedia functionality, which allows the provision of services such as video calls, music and games. In these example devices, the multimedia functionality may be described by APIs, and may be provided by software modules such as Digital Signal Processing (DSP) codecs. In some examples some of the software modules may be the same as the software modules provided in the telephone functionality, for instance, voice processing. Accordingly, in some examples there may be duplication of coding in some telecommunication devices.

This duplication means in some examples that more memory is used, thus impacting on the physical characteristics and power usage of the device. Furthermore, in some examples more maintenance of the software has to be provided resulting in higher costs and more inconvenience to both users and suppliers.

It is therefore desirable in some examples to remove one copy of the duplicate coding. However, removal of one copy of the coding may, in some examples, impact on the performance of the device in that during start-up certain functionality may take longer to be provided/made available. Typically, this may not cause any problems. However, there are certain circumstances in some examples where a delay in being able to use a particular function of the device is detrimental. For instance, a user may need to make a telephone call to an emergency service, such as police, fire and ambulance services.

The maximum allowable time it takes a user to be able to make a telephone call to one of these emergency services on a communications device following power-up, or re-boot, or from standby mode, may be determined in some examples by national and/or international standards. Accordingly, it can be important in some examples that if duplicate coding is removed the performance of the device is not impaired in this regard.

In a first example embodiment, there is provided a communications device such as a mobile telecommunications handset in which several different functions are provided, such as the ability to make telephony calls, send email or text messages, and handle multimedia, such as by producing or reproducing multimedia content such as audio, video, or images. To perform the different functions various code modules are provided that perform various tasks relating to the functions. In order to reduce code duplication, and hence attain the various advantages thereof (or avoid the various drawbacks of having code duplication) noted above, the device of the first example embodiment makes use of the same code to perform a task that is common to multiple different functions. In particular, in one example where the telephony function requires tasks to be performed, code that is provided nominally for other functions, such as for example a multimedia function, may be used to perform its task for the telephony function. For example, both the telephony function and the multimedia function may require use of a voice processing task, and hence a voice processing code module that performs voice processing is provided. In this example, the voice processing code module is part of the multimedia function, and hence considered to be multimedia functionality.

However, as noted above, in the present first example embodiment telephony functionality should be made available quickly when the device is initiated, such as on re-boot, power-on, or on a return from a low-power standby mode. That is, where the telephony functionality relies on a task that is performed by code that is part of another function, the time to operability of the telephony functionality should not be unduly delayed by having to wait for the other function becoming operable. In the first example embodiment this is provided by initialising telephony functionality and initialising other functionality on which the telephony functionality at least partially relies in two sequential phases. In particular, those parts of the other functionality on which the telephony functionality relies are initialised before any other parts on which the telephony functionality does not rely.

Thus, for example, where the telephony functionality borrows a particular task from a multimedia function, that part of the multimedia function that performs that task (for example the specific code module or the like) is initialised in a first phase before other parts of the multimedia function are then initialised in a second phase.

In one example it is possible that the telephony functionality is initialised first, followed by the multimedia functionality being initialised in its entirety. Alternatively, in another example a first phase of the multimedia functionality on which the telephony functionality relies could be initialised, followed by the initialisation of the telephony functionality. In this latter case, the second phase of the multimedia functionality could be initialised either after the telephone functionality has been initialised or at least partially simultaneously therewith. In another example embodiment, the telephony functionality and the first phase of the multimedia functionality could be initialised at least partially simultaneously, followed by the second phase of the multimedia functionality being initialised.

In this regard, in the above examples the term “initiating” may mean changing the device from a state where a certain function cannot be performed because the device is not ready, to a state where the device can perform that function. For instance, in one example it may mean following a power-on or power-up event, or following a re-boot, or changing from a stand-by mode in which the particular function is not available to an operational mode where that function is available.

Furthermore, in the above examples the term “initialising telephony functionality” means preparing the device for telephony usage. For instance, in one example it may mean the loading of software coding, possibly in the form of software modules, into executable memory such that the device is able to perform a telephone function facilitated by that coding, for instance, so that the key pad may be used to enter a telephone number, and/or that number then being used to connect the telecommunications device to another telecommunications device. Alternatively, in another example the coding may already be loaded and the initialisation may mean carrying out any necessary steps in order to allow telephony functionality to be used and/or operate.

With regard to the term “initialising multimedia functionality”, this is taken to mean, in an example embodiment, preparing the device for multimedia usage. For example, in one embodiment this may involve the loading of software coding, possibly in the form of software modules, into executable memory such that the device is able to perform a multimedia function facilitated by that coding, for example, so that the loud speaker may be used for listening, and/or a camera may be used to take photographs. In another example embodiment the coding may already be loaded and the initialisation may mean carrying out any necessary steps in order to allow multimedia functionality to be used and/or operate.

An example of the initialisation of the multimedia functionality occurring in two sequential phases is where at least one component is initialised in a first phase and at least one other component is initialised in a second phase.

In one embodiment, in the first of the two said sequential phases at least a voice processing component is initialised and in the second of the two said sequential phases other multimedia components are initialised.

In one example it is possible that the initialisation in the first of the two said sequential phases occurs synchronously. The term “synchronously” may take its usual meaning. For instance, it may be taken to mean that the coding that is initialised is independent of other coding in that it does not require any other applications to have already been loaded into executable memory for it to be loaded and/or installed itself.

In one example the initialisation in the second of the two said sequential phases may occur either synchronously or asynchronously. The term “asynchronously” may take its usual meaning. For instance, in one example it may be taken to mean that the coding that is initialised is dependent of other coding in that it may have to “refer” to other applications in order for itself to be loaded and/or installed correctly. These other applications may already be installed or may have to be installed on request. If the latter, then the initialisation of the second phase may have to pause and wait until that other coding or application is installed before continuing.

In one example the telecommunications device may be able to facilitate the making of a telephone call following the initialisation of the parts of the multi media function required by the telephony function in the first of the two sequential phases. Since it will take less time to initialise only one or some of the multimedia components as opposed to all of the multimedia components, this may be important in the case of a device both meeting the requirements of standards, as discussed above, and of providing an efficient and reliable service to users. This may be especially the case if a user needs to make an emergency call.

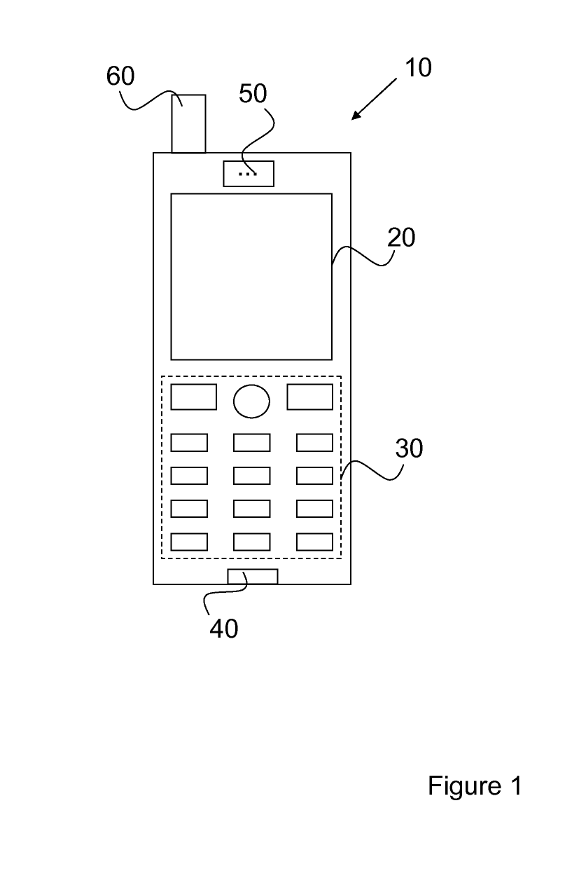

A second example embodiment will be described next with respect to FIGS. 1 to 3.

FIG. 1 represents a smartphone 10 of the second example embodiment that comprises a keypad 30, a display screen 20, a microphone 40, a speaker 50 and an antenna 60. The smartphone 10 is capable of being operated by a user to perform a variety of different functions, such as, for example, hosting a telephone call, browsing the internet or sending an email.

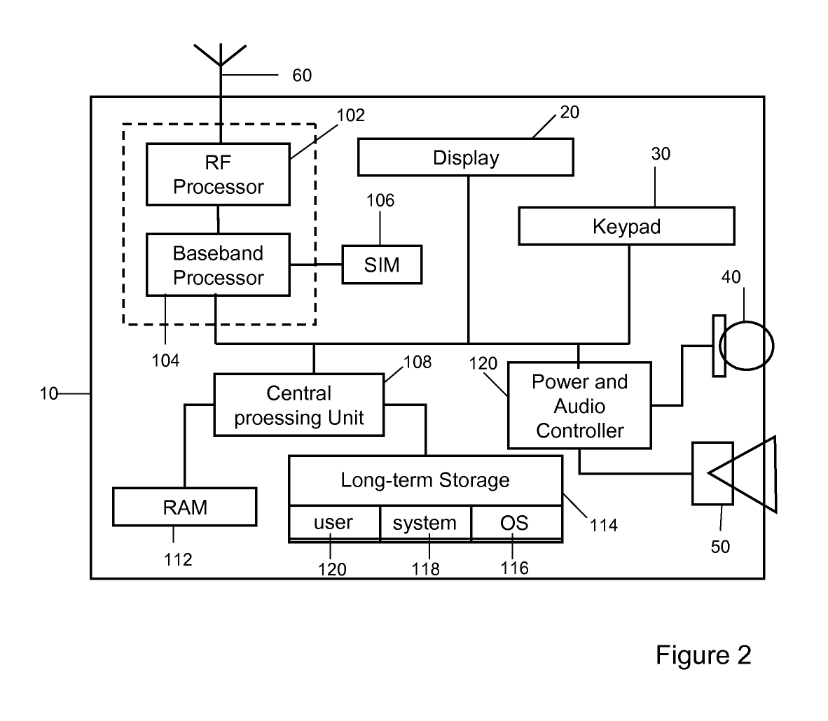

FIG. 2 shows a schematic view of some of the internal hardware elements of the known smartphone 10 of the second example embodiment. With reference to FIG. 2, the smartphone 10 comprises hardware to perform telephony functions, together with a central processing unit (CPU) 108 and corresponding support hardware to enable the phone to have other functions which are desired by a smartphone, such as messaging, internet browsing, email functions and the like. In FIG. 2 the telephony hardware is represented by the RF processor 102 which provides an RF signal to the antenna 60 for the transmission of telephony signals, and the receipt therefrom. Additionally provided is baseband processor 104, which provides signals to, and receives signals from, the RF Processor 102. The baseband processor 104 also interacts with a subscriber identity module 106, as is well known in the art.

In this example, the keypad 30 and the display 20 are controlled by the CPU 108. A power and audio controller 120 is also provided to supply power from a battery (not shown) to the telephony subsystem, the CPU, and the other hardware. Additionally, in this example the power and audio controller 120 also controls input from the microphone 40, and audio output via the speaker 50.

In order for the CPU 108 to operate, in this example embodiment various different types of memory are provided. Firstly, the smartphone 10 includes Random Access Memory (RAM) 112, connected to the CPU 108, into which data and program code can be written and read from at will. Code placed anywhere in RAM can be executed by the CPU 108 from the RAM. RAM 112 represents a volatile memory of the smartphone 10.

Secondly, in this example the smartphone 10 is provided with non-volatile long-term storage 114 connected to the CPU 108. The long-term storage 114 comprises in this example three partitions, being an operating system (OS) partition 116, a system partition 118 and a user partition 120. In this example embodiment, the OS partition 116 contains the firmware of the computing device which includes an operating system. An operating system is necessary in order for the CPU to operate and therefore, the operating system must be started as soon as the smartphone system 10 is first switched on.

As stated, the representation of FIG. 2 is schematic only. In practice, the various functional components may be provided in fewer or in more components than are shown. For example, the long-term storage 114 may comprise NAND flash, NOR flash, a hard disk drive or a combination of these. In other examples different storage devices may be used.

In the second example embodiment presently described the CPU 108 runs a central repository server which controls and manages various software elements on the computing device. One of the roles of the central repository server in this example is to organise and manage the various firmware settings stored on the OS partition 116. For example, the central repository server stores and maintains cyclic redundancy check values for the firmware settings and thereby detects when any of the settings have been corrupted. Typically, in this example permission to write to the OS partition 116 is restricted to prevent corruption of the data it contains and thereby, preserve the integrity of the computing device. Accordingly, in this example the OS partition 116 can be thought of as a read-only portion of the long-term storage 114.

In the presently described second example embodiment other computer programs may also be stored on the long-term storage 114, such as application programs, software modules, and the like. In particular, in this example application programs which are mandatory to the device, such as, in the case of a smartphone, communications applications and the like are typically stored in the system partition 118. In this example the application programs stored on the system partition 118 would typically be those which are bundled with the smartphone by the device manufacturer when the phone is first sold. Typically, in this example permission to write to the system partition 118 is less restricted than the OS partition 116 because, the data contained on the system partition 118 is often not as critical to the device's fundamental operation. Accordingly, in this example the system partition 118 can be thought of as a writable portion of the long-term storage 114.

In this example application programs which are added to the smartphone by the user would usually be stored in the user partition 120.

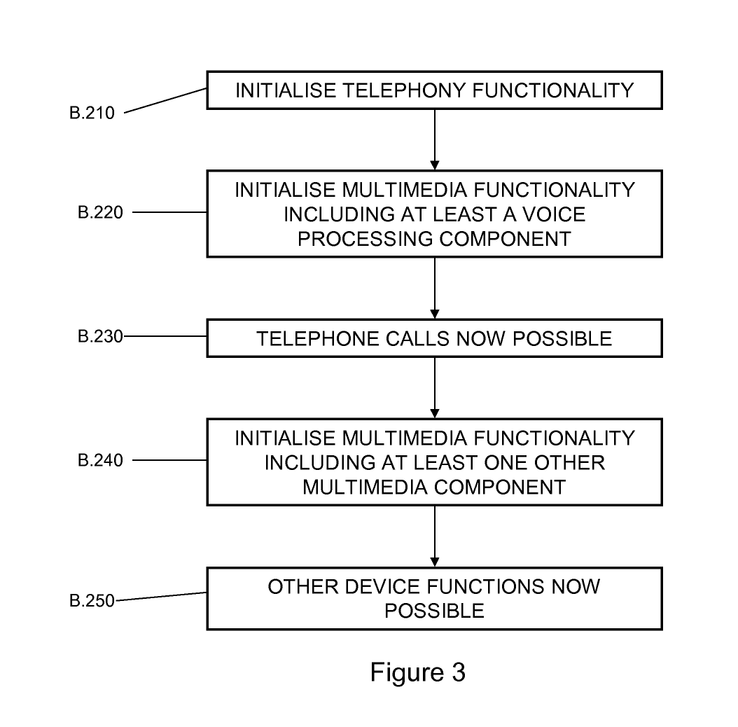

FIG. 3 is a flow diagram showing a method of initiating a telecommunications device in the presently described second example embodiment. In this example the device in question comprises at least telephony functionality and multimedia functionality. For example, the telephony functionality includes software modules which control such things as the key pad. However, this functionality does not, for example, include a voice processing component. Rather, in this example this component is included in the multimedia functionality. Such an arrangement avoids duplication of this component, which otherwise may be included in both functionalities, such that less memory is occupied.

At first (see block 210), in this example the telephony functionality of the device is initialised. In this example this may include the loading of particular software modules into executable memory. This allows the key pad to be used to enter a telephone number of another telecommunications device for connection therewith.

Next (see block 220), in this example the multimedia functionality is initialised including at least one voice processing component. In this example, once this component is initialised, by the loading of appropriate software modules into executable memory, telephone calls may be made from the device 230.

Thereafter, in this example further components of the multimedia functionality are initialised (see block 240). In this example this allows other functions 250 to be operated on the device which require multimedia functions other than purely voice processing. For example, a camera or video conferencing application may be used.

In this way, in this example a telecommunications device may be provided which avoids duplication of coding but which may be initialised without undue delay.

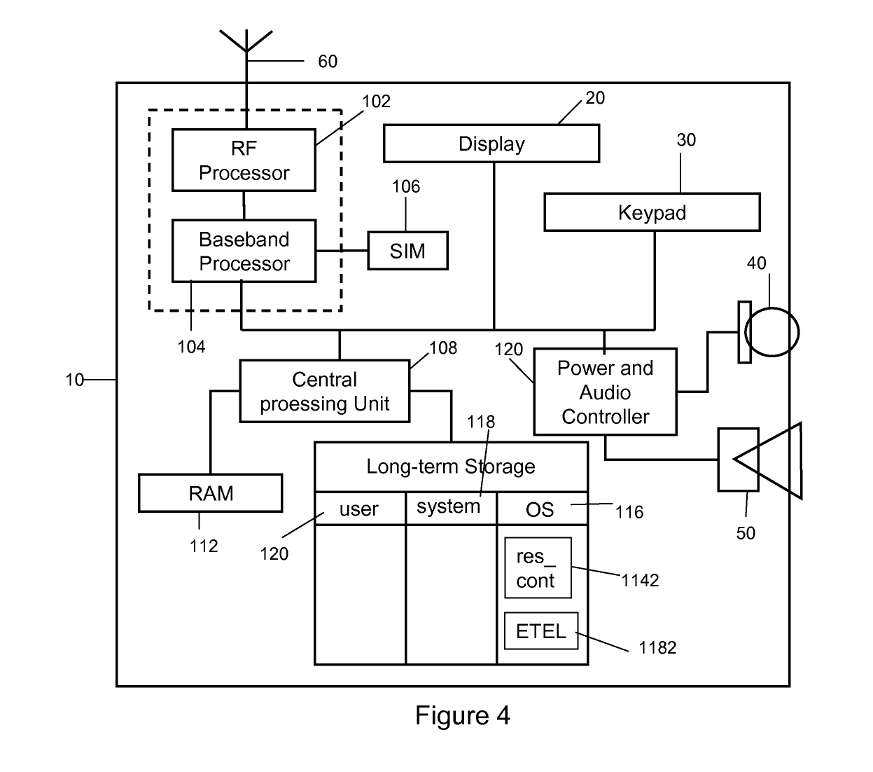

A third example embodiment will be described, purely by way of example, with reference to FIGS. 4 to 6.

In the third example embodiment, FIG. 4 illustrates a smartphone 10 of the present example. The smartphone 10 incorporates many of the identical system elements as the smartphone 10 of the second example embodiment discussed above, further description of which will not therefore be undertaken.

In the present example, the OS partition 116 of long term storage 114 contains software modules to cause the smartphone device 10 to operate. In this example, an ETEL server module 1182 is provided in the OS partition 114, as well as a resource controller module 1142. In this example, the ETEL server module 1182, is loaded on boot-up, restart, or return from a standby mode, in order to provide, in combination with the RF processor 102, baseband processor 104, and SIM 106, telephony functionality to the smartphone device 10. However, in this example ETEL server 1182 does not contain all of the code necessary for telephony functionality, and requires additional tasks to be performed by the resource controller module 1142.

In this example, resource controller module 1142 is a core entity used for resource policy management. The resource controller module 1142 makes decisions related to resource management of the smartphone device 10, and, in this example, policy management of the device 10. In other examples, the resource controller module may make decisions relating to other matters in the smartphone device. However, in the present example, it is the resource controller module 1142 that takes decisions relating to resource management and policy management and it must be initialised before it is able to make any such decision. In this example, initialisation of the resource controller 1142 refers to loading relevant parts of the resource controller module 1142 so that they may be run such that their logic can then be used to take decisions.

In the present example resource controller module 1142 makes resource and policy management decisions for the ETEL server 1182. This has the advantage that the ETEL server 1182 need not contain code in order to make resource and policy management decisions. Instead, in this example it is able to delegate resource and policy management decisions to the resource controller module 1142.

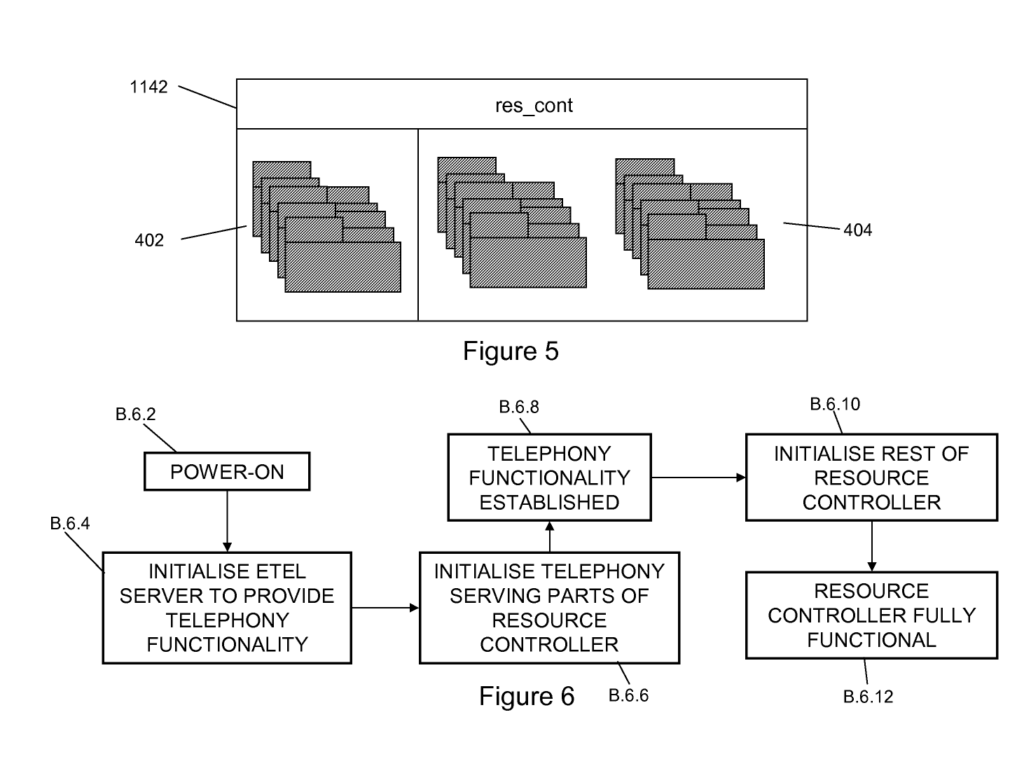

In this respect, as shown in FIG. 5, in this example resource controller module 1142 is split into at least two parts. A first part 402 of resource controller module 1142 contains code and functions which are required to provide resource and policy management for the telephony functionality provided by the ETEL server 1182. The other part of the resource controller module 1142 contains code and functions 404 that provide the remainder of resource controller module 1142's functionality, for example to make other resource and/or policy management decisions for other subsystems of the smartphone device 10. In this example, first part 402 of the resource controller module 1142 that relates to the telephony functionality provided by the ETEL server is much smaller than the second part of the resource controller module 404, which provides the remainder of the resource controller module 1142's functionality.

In this example, with the above arrangement should it be necessary to initialise all of the parts of the resource controller module 1142 before resource controller module 1142 is able to make resource or policy management decisions, then such initialisation can take a significant amount of time. However, the ETEL server 1182 only requires a subset of the resource controller module 1142's functionality, and in particular the subset provided by the code and functions in the first part 402 of resource controller module. In this example, therefore, in order to obtain telephony functionality as soon as possible upon initial boot-up, restart, or on or return from a standby, the first part 402 of resource controller module 1142 is initialised such that it becomes able to function in advance of the initialisation of the second part 404 of resource controller 1142, which relates to the remainder of its functionality.

FIG. 6 illustrates such operation of the present example in more detail. In this example, firstly, as shown in block 6.2, the smartphone device is powered on, restarted, returned from a standby mode, or otherwise initiated. Then, as shown at block 6.4, the ETEL server is initialised, such that the smartphone device 10 is able to provide telephony functionality. However, as noted previously, in this example the ETEL server requires resource and policy management decisions to be undertaken by the appropriate parts of the resource controller module 114, which, as yet, have not been initialised. Therefore, at block 6.4 the smartphone device 10 is not yet able to provide full telephony functionality.

Therefore, in this example, at block 6.6 the first part 402 of the resource controller 1142 that serves the needs of the ETEL server, and in particular makes resource and policy management decisions for the ETEL server, is then initialised. After this, as shown at block 6.8, telephony functionality is established, and it would then be possible for the user of the smartphone device, in this example, to make a telephone call, such as, for example, an emergency telephone call.

In the present example, therefore, the ETEL server is initialised prior to the telephony serving first part 402 of the resource controller. In another example, however, the telephony serving part 402 of the resource controller may be initialised prior to the ETEL server. In yet another example, the ETEL server and the telephony serving part 402 of the resource controller 1142 may be initialised substantially simultaneously, that is, in one example, initialisation of the ETEL server, and the telephony serving part 402 of the resource controller 1142 may proceed in parallel or on a time divided basis.

Once telephony functionality has been established, in the present example, as shown at block 6.10, the rest of the resource controller is initialised. In this example, this means that the second part 404 of the resource controller, which relates to the remainder of the resource controller's functionality is then initialised. After this step, in this example the resource controller is fully functional, as shown at B 6.12. At this point, in this example, the resource controller is able to serve requests both from the ETEL server, as well as from other subsystems of the smartphone device 10.

In this example, therefore, the ETEL server may share code with the resource controller, and hence reduce the amount of code duplication on the device. However, in order to ensure that telephony functionality is provided as quickly as possible, in this example the telephony-serving parts of the resource controller are loaded or initialised and rendered operable before the other parts of the controller. In this way, in this example telephony functionality is not dependent on initialisation of all of the parts of the resource controller, but only those parts that are actually needed.

Without in any way limiting the scope, interpretation, or application of the claims appearing below, a technical effect of one or more of the example embodiments disclosed herein is that telephony functionality, for example the ability to make emergency calls, is obtained quickly. Another technical effect of one or more of the example embodiments disclosed herein is that code duplication is reduced, without impacting performance. In one example, important telephony functionality is obtained quickly on device start-up, even though the telephony functionality may share code with other functions, or rely upon other functions to make processing decisions for the telephony functionality.

A further example of the invention provides a computer program or suite of computer programs so arranged such that when executed by a computer it/they cause the computer to operate in accordance with any of the examples described above. Another example of the invention provides a computer-readable storage medium storing a computer program or at least one of the suite of computer programs according to the previous example. The computer readable storage medium is any storage medium known in the art, such as a HDD, solid state memory such as Flash memory, RAM, ROM, or disc based media.

If desired, the different functions discussed herein may be performed in a different order and/or concurrently with each other. Furthermore, if desired, one or more of the above-described functions may be optional or may be combined.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are several variations and modifications which may be made without departing from the scope of the present invention as defined in the appended claims.

It is further to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof.

Similarly, it is to be noticed that the term “connected”, used in the description, should not be interpreted as being restricted to direct connections only. Thus, the scope of the expression “a device A connected to a device B” should not be limited to devices or systems wherein an output of device A is directly connected to an input of device B. It means that there exists a path between an output of A and an input of B which may be a path including other devices or means. “Connected” may mean that two or more elements are either in direct physical or electrical contact, or that two or more elements are not in direct contact with each other but yet still co-operate or interact with each other.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may refer to different embodiments. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

In the description provided herein, numerous specific details are set forth. However, it is understood that embodiments of the invention may be practised without these specific details. In other instances, well-known methods, structures and techniques have not been shown in detail in order not to obscure an understanding of this description.

1. A method, comprising:
initiating telephony functionality in a communications device, the telephony functionality being provided by a telephony function and one or more telephony-related parts of one or more other functions, the one or more other functions further having non-telephony related parts, the initiating further comprising:
initialising the telephony function; and
initialising the one or more telephony-related parts of the one or more other functions prior to the non-telephony related parts.

2. A method according to claim 1, wherein the one or more other functions includes multimedia functionality; and
wherein the telephony related parts of the multimedia functionality includes at least a voice processing component.

3. (canceled)

4. A method according to claim 1, wherein the one or more other functions includes resource management functionality.

5. A method according to claim 1, wherein the one or more other functions includes policy management functionality.

6. A method according to claim 1, wherein the communications device is able to facilitate the making of a telephone call following the initialisation of the one or more telephony-related parts of the one or more other functions.

7. A method according to claim 1, wherein the initialisation of the telephony-related parts of the other functions occurs synchronously.

8. An apparatus, comprising:
at least one processor; and
at least one memory including computer program code
the at least one memory and the computer program code configured to, with the at least one processor, cause the apparatus to perform at least the following:
initiate telephony functionality in the apparatus, the telephony functionality being provided by a telephony function and one or more telephony-related parts of one or more other functions, the one or more other functions further having non-telephony related parts, the initiation further comprising:
initialize the telephony function; and
initialize the one or more telephony-related parts of the one or more other functions prior to the non-telephony related parts.

9. An apparatus according to claim 8, wherein the one or more other functions includes multimedia functionality; and
wherein the telephony related parts of the multimedia functionality includes at least a voice processing component.

10. (canceled)

11. An apparatus according to claim 8, wherein the one or more other functions includes policy management functionality.

12. (canceled)

13. An apparatus according to claim 8, wherein the apparatus is able to facilitate the making of a telephone call following the initialisation of the one or more telephony-related parts of the one or more other functions.

14. An apparatus according to claim 8, wherein the initialisation of the telephony-related parts of the other functions occurs synchronously.

15. An apparatus, comprising:
a telephony module that provides at least in part telephony functionality to the apparatus; and
one or more further functional modules, having telephony related parts and non-telephony related parts, the telephony-related parts being operable with the telephony module to provide telephony functionality to the apparatus;
wherein, on initiating the apparatus the telephony module is initialised, and the telephony-related part(s) of the or each further functional modules is/are initialised prior to the non-telephony-related parts.

16. An apparatus according to claim 15, wherein the one or more other functional modules includes a multimedia module; and
wherein the telephony related parts of the multimedia module includes at least a voice processing component.

17. (canceled)

18. An apparatus according to claim 15, wherein the one or more other functional modules includes a resource management module.

19. An apparatus according to claim 15, wherein the one or more other functions includes a policy management module.

20. An apparatus according to claim 15, wherein the apparatus is able to facilitate the making of a telephone call following the initialisation of the one or more telephony-related parts of the one or more other functional modules.

21. An apparatus according to claim 15, wherein the initialisation of the telephony-related parts of the other functional modules occurs synchronously.

22. A computer program or suite of computer programs so arranged such that when executed by a computer it/they cause the computer to operate in accordance with the method of claim 1; and
wherein the computer program or suite of computer programs is a computer program product comprising a computer-readable medium bearing computer program code embodied therein for use with a computer.

23. (canceled)
